(19) United States
(12) Patent Application Publication
(10) Pub. No.: US 2026/0099560 A1
(43) Pub. Date: Apr. 9, 2026

(54) ACCESSIBILITY HUB FOR ACCESSIBILITY THEME MANAGEMENT AND DYNAMIC ACCESSIBILITY THEME GENERATION

(71) Applicant: Capital One Financial Corporation, McLean, VA (US)

(72) Inventors: Daniel A. Gisolfi, Hopewell Junction, NY (US); Lise Noble, Chapel Hill, NC (US); Andrew Bryan Smith, Apex, NC (US); Aaron Reed, Cary, NC (US); Andrew Duckett, Lake Forest, IL (US); Yessel Hinojosa Martinez, Austin, TX (US); Bryce Curtis, Apex, NC (US); Keith Smith, Raleigh, NC (US)

(21) Appl. No.: 18/907,206

(22) Filed: Oct. 4, 2024

(51) Int. Cl. G06F 16/957; G06F 40/186; H04L 9/32

(52) U.S. Cl. CPC G06F 16/9577; G06F 40/186; H04L 9/3213

(57) ABSTRACT

An “accessibility hub” for content accessibility services enables impaired content consumers to create user profiles including personalized accessibility themes that define accessibility preferences for viewing published content. Further, the accessibility hub enables content producers to access accessibility theme templates that can be used by the content producers to publish content in a manner that is accessible to impaired content consumers. Further yet, anonymized accessibility preference data may be aggregated and analyzed for use in generating new accessibility themes for various impairments, based on which impairment-specific accessibility settings and themes may be recommended and/or dynamically generated.

### BACKGROUND

A wide range of impairments, such as vision impairments, hearing impairments, learning impairments, motion impairments, cognition impairments, etc., prevent billions of people globally from accessing and interacting with physical and digital content that is socially and economically necessary. The demand for inclusive content that provides accessibility to people with such impairments is rising, as is the need to provide content consumers with tools to customize accessibility settings, along with the need to provide content producers with tools to consistently generate inclusive, accessible content.

### OVERVIEW

Disclosed herein is new software technology related to content accessibility services that provides an “accessibility hub” that offers various services related to creating customized user profiles based on user preferences, aggregating (anonymized) user preference data for use in creating new accessibility themes for various impairments, and dynamically determining impairment-specific accessibility settings and themes based on analysis of anonymized user preferences.

In one aspect, the disclosed technology may take the form of a method to be carried out by a computing platform that involves (i) receiving, from a computing device associated with a given user, a request to create an accessibility theme for viewing digital content; (ii) causing the computing device to display a series of user interface views that enable the given user to provide user input configuring the accessibility theme; (iii) receiving, from the computing device, data indicating a set of accessibility preferences that define how digital content is to be published for display to the given user according to the accessibility theme; (iv) causing storage of profile data in association with the given user, the profile data indicating the set of accessibility preferences that define how content is to be published for display to the given user according to the accessibility theme; (v) receiving, from the computing device, data indicating user authorization to share the set of accessibility preferences with one or more content producers; (vi) based on receiving the data indicating the user authorization, transmitting, to the computing device, an access token for accessing the set of accessibility preferences; (vii) after transmitting the access token to the computing device, receiving, from a content producer computing platform, a request for the set of accessibility preferences, the request comprising the access token; and (viii) based on receiving the request for the set of accessibility preferences comprising the access token, transmitting the set of accessibility preferences to the content producer computing platform.

In an example, the method further involves receiving, from the computing device, an indication of a given user impairment, wherein the profile data further comprises data indicating the given user impairment.

In an example, the method further involves (i) based on receiving the data indicating the user authorization to share the set of accessibility preferences with one or more content producers, generating the access token; and (ii) before transmitting the set of accessibility preferences to the content producer computing platform, validating the access token received from the content producer computing platform.

In an example, the method further involves: based on the set of accessibility preferences, generating a template comprising accessibility-compliant design data that is usable by the content producer computing platform for publishing content according to the accessibility theme, wherein transmitting the set of accessibility preferences to the content producer computing platform comprises transmitting the template to the content producer computing platform. In one embodiment, the template may comprise a cascading style sheet (CSS) file or a JavaScript object notation (JSON) file.

In an example, the computing device is a first computing device, the given user is a first user, the set of accessibility preferences is a first set of accessibility preferences, the accessibility theme is a first accessibility theme, and the method further involves: (i) receiving, from a second computing device associated with a second user, data indicating a second set of accessibility preferences that define how digital content is to be published for display to the second user according to a second accessibility theme; (ii) causing storage of profile data in association with the second user, the profile data indicating the second set of accessibility preferences that define how content is to be published for display to the second user according to the second accessibility theme; and (iii) based on at least (a) the first set of accessibility preferences and (b) the second set of accessibility preferences, generating a new set of accessibility preferences that define how content is to be published for display according to a new accessibility theme.

In one embodiment, generating the new set of accessibility preferences that define how content is to be published for display according to the new accessibility theme may comprise utilizing one or more machine learning models to determine, from respective sets of accessibility preferences for a plurality of users, one or more user preference commonalities, wherein the new set of accessibility preferences comprise the one or more user preference commonalities. In one instance of such an embodiment, the method further involves (i) receiving, from the content producer computing platform, a request for the new set of accessibility preferences, wherein the request does not comprise the access token; and (ii) based on receiving the request for the new set of accessibility preferences: transmitting, to the content producer computing platform, a template comprising accessibility-compliant design data corresponding to the new set of accessibility preferences. In another instance, the method further involves (i) receiving, from a third computing device associated with a third user, (a) a second request to create an accessibility theme for viewing digital content and (b) an indication of a given impairment for the accessibility theme; (ii) based on the respective sets of accessibility preferences for the plurality of users, identifying one or more recommended accessibility preferences associated with the given impairment; and (iii) causing the third computing device to display a respective indication of each recommended accessibility preference.

In one example, the set of accessibility preferences indicate one or more of (i) a text color preference, (ii) a background color preference, (iii) a font preference, (iv) border preferences, or (v) bevel preferences.

In one example, the set of accessibility preferences indicate one or more of (i) a target area preference, (ii) a grid system preference, (iii) animation preferences, or (iv) sound preferences.

In another aspect, disclosed herein is a computing platform that includes a communication interface, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing methods.

In still another aspect, disclosed herein is a non-transitory computer-readable medium provisioned with program instructions that, when executed by at least one processor, cause a computing platform to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example computing environment in which example embodiments may be implemented.

FIG. 2 depicts a flow diagram of example functionality that may be carried out for facilitating profile registration and accessibility theme creation in accordance with aspects of the disclosed technology.

FIG. 3 depicts a flow diagram of example functionality that may be carried out for facilitating accessibility theme creation in accordance with aspects of the disclosed technology.

FIG. 4 depicts a flow diagram of example functionality that may be carried out for facilitating accessibility theme template retrieval in accordance with aspects of the disclosed technology.

FIG. 5 depicts a structural diagram including example software subsystems of an example back-end computing platform that may be configured to carry out back-end computing platform functionality according to the disclosed software technology.

FIG. 6 depicts a structural diagram of an example back-end computing platform that may be configured to carry out back-end computing platform functionality according to the disclosed software technology.

FIG. 7 depicts a structural diagram of an example end-user device that may be configured to carry out end-user device functionality according to the disclosed software technology.

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### DETAILED DESCRIPTION

E-accessibility, also referred to as web accessibility, pertains to the design of websites, mobile applications, and other digital media content in a way that attempts to provide increased accessibility to content consumers with impairments. Such impairments may take various forms. As some non-exhaustive examples, an impairment may take the form of a visual impairment that affects a consumer's ability to see (e.g., color-blindness, etc.), an auditory impairment that affects a consumer's ability to hear, a learning impairment that affects a consumer's ability to understand or use spoken or written language (e.g., dyslexia, etc.), a motor impairment that affects a consumer's ability to perform coarse and/or fine motor functions (e.g., manipulating a mouse and/or keyboard, etc.), a motion impairment that affects a consumer's sensitivity to visual motion and/or repetitive patterns (e.g., vertigo, etc.), an impairment that affect's a consumer's ability to focus (e.g., ADHD), among numerous other examples.

As used herein, the term “content consumer” may refer to a user with any impairment that requires content (e.g., digital and/or physical content) to be displayed in a particular way in order for the content to be accessible to the user. In this respect, an “impairment” as used herein may include any condition that presents a barrier to a consumer accessing content. For instance, an impairment as discussed herein may include, as some non-limiting examples, an impairment that falls within the boundaries of a clinically-defined medical condition or disability (e.g., dyslexia, color-blindness, ADHD, pregnancy, etc.), a visual impairment (e.g., near-sightedness, far sightedness, light sensitivity, astigmatism, etc.), a motion impairment (e.g., vertigo), or any other auditory, learning, or cognitive impairment, among many other possibilities.

The types of impairments noted above and the resulting lack of access to accessible content, particularly web-based content, tends to negatively impact the quality of life for large groups of consumers today. By some estimates, over half of the world's population (i.e., approximately 5 billion people) use the internet and social media in some form, and over a quarter (i.e., at least 2.2 billion people) suffer from some form of impairment including those described herein. The lack of access to accessible web-based content for impaired consumers has negative economic effects as well. For example, vision impairments alone present a substantial global financial burden, with the global cost of productivity losses associated with vision impairment estimated to be USD 411 billion annually.

To assist content designers and content producers with the design and creation of web-based content that is accessible to people with impairments like those described herein, various standards have been developed. As used herein, the term “content designer” may refer to any entity that is responsible for determining how published content should appear visually when published. Further, as used herein, the term “content producer” may refer to any entity that is responsible for publishing content for consumption by consumers. A content producer may take various forms, some examples of which include desktop publishers, corporate websites, user interface designers, interface design tool vendors, printing vendors, and financial institutions, among various other possibilities.

One prominent example of accessibility standards that have been developed to facilitate provision of accessible content to impaired content consumers is the Web Content Accessibility Guidelines (WCAG) (e.g., WCAG version 2.1), published by the Web Accessibility Initiative (WAI) of the World Wide Web Consortium (W3C), which provides a set of principles, guidelines, and success criteria that can be used to evaluate the accessibility of content. With respect to the success criteria, the WCAG 2.1 standard provides multiple levels of conformance (i.e., levels A, AA, and AAA, with increasingly stringent requirements) that can be achieved by satisfying the success criteria associated with each given level.

The WCAG 2.1 success criteria may take various forms and may correspond to the design of visual elements in a way that has the effect of addressing the accessibility challenges associated with different types of impairments. As one example, the success criteria may designate a minimum contrast level for different types of visual content, (e.g., text, buttons, etc.), where higher conformance levels have a higher minimum contrast level. As another example, the success criteria may designate a minimum target size (e.g., in pixels) for pointer inputs, where higher conformance levels have a higher minimum target size. As yet another example, the success criteria may require that users are able to pause, stop, or hide certain types of moving, blinking, or scrolling content. Numerous other examples of success criteria from WCAG 2.1 and other accessibility design standards are also possible.

Some governmental agencies and businesses worldwide have embraced these accessibility standards and require compliance with a given WCAG 2.1 level for designers and creators of their own web-based content. However, implementation of WCAG 2.1 and similar guidelines in the design and creation of web-based content remains a complex undertaking, and attaining accessibility compliance is challenging. Consequently, many current content creation workflows include little or no consideration of accessibility design, and the resulting content created by such workflows is often not accessibility-compliant in various ways. Further, many content creation workflows that do consider accessibility design do so in a post-hoc manner, evaluating already-created content and then attempting to adjust the content as necessary to try to achieve some degree of accessibility compliance. Moreover, while such standards have been developed for web-based content, no such accessibility standards are available for physical (e.g., printed) content. Thus, there are no existing content creation frameworks to assist content designers and content producers with creating and publishing accessibility-compliant content in physical form.

Certain software tools and technology have been developed in an effort to provide web accessibility for impaired users. Such software tools and technology enable an impaired user to adjust accessibility settings (i.e., settings defining font type, font size, color preferences, spacing, etc.) such that published digital content is modified and presented according to the user's desired preference. However, these existing tools/technology present certain challenges. Typically, existing web accessibility tools are provided in the form of a browser extension or mobile application that a user must download and install (e.g., in a web browser, on a computing device, etc.). Thereafter, when viewing digital content, the user must run the installed software tool and then configure various accessibility settings to adjust the displayed digital content until it becomes accessible to the user.

Further, existing accessibility tools do not provide an option to save different accessibility settings that can be selected and applied automatically to different types of content that a user will view. For instance, existing accessibility tools typically target certain types of digital content. For example, certain accessibility tools enable users to adjust accessibility settings for digital web content, such as digital content that is accessed and displayed via the web (e.g., using a browser), whereas certain other accessibility tools enable users to adjust accessibility settings for digital content that is accessible offline, such as electronic reading material (e.g., e-books) that is downloaded to a user's computing device and accessed via a digital reader application. Thus, an impaired user may need to download and install multiple individual software tools in order to adjust accessibility settings for different types of digital content the user consumes, as adjustments made to a first type of digital content (e.g., web content) are not necessarily propagated to a second type of digital content (e.g., e-books). Moreover, even in instances where impaired users are able to adjust accessibility settings (e.g., in a web-only context via a browser extension, in an in-app only content via a given mobile application, etc.), the existing tools use a “brute-force” approach to retroactively modify content that has already been published by the content producer, often without regard for accessibility of the content. As such, there are limitations on the types/extent of modifications that can be applied, which may impede the user's access to the content being consumed. For instance, certain impaired users may prefer to configure settings related to text layout or positioning of embedded images in order to access content. However, such settings are typically unavailable for modification using existing accessibility tools.

Furthermore, existing accessibility tools do not provide a centralized mechanism for an impaired user to configure accessibility settings that can be applied automatically to all of the types of content that the user will view using various different applications (e.g., web applications, mobile applications, etc.) that run independently on the user's computing device. This can be particularly problematic in instances where certain applications do not provide options to configure accessibility settings for those applications.

Further yet, existing accessibility tools focus largely on adjusting the display of digital content and do not typically address accessibility of printed (e.g., physical) content, such as credit cards, drivers licenses, printed tickets, bank checks, promotional material, or business correspondences, as some nonlimiting examples. For instance, existing accessibility tools do not provide a centralized mechanism for an impaired user to configure accessibility settings that can be applied to printed content that the user may consume.

Further still, existing accessibility tools do not provide a mechanism for content producers to obtain accessibility preferences information that will enable them to publish content in the first instance—either digitally or physically—in a manner that is accessible to given impaired users and/or users with a given type of impairment.

Furthermore, existing accessibility tools do not provide a mechanism for leveraging crowd-sourced accessibility preferences data from many impaired users to dynamically generalize accessibility settings that may otherwise be unavailable.

Despite the introduction of web-accessibility standards, software technology and tools intended to facilitate the provision of accessible content to impaired users have shortcomings, as discussed above.

To address these and other shortcomings, Discover Financial Services (“DFS”) has been developing software technology and tools that provide increased capabilities for content designers and content producers to create accessible content that may be consumed by impaired users. For instance, DFS has developed accessibility-aware design services that include pre-encoded logic for satisfying accessibility compliance standards, more information about which can be found in U.S. application Ser. No. 18/478,267, filed Sep. 29, 2023, and entitled “Accessibility-Aware Design Services,” and U.S. application Ser. No. 18/478,443, filed Sep. 29, 2023, and entitled “Theme-Builder for Accessibility-Aware Design Services,” the contents of each of which are incorporated by reference herein in their entirety.

Continuing with these advancements, disclosed herein is new software technology related to content accessibility services. At a high level, the disclosed software technology provides an “accessibility hub” that offers various services related to creating customized user profiles based on user preferences, aggregating (anonymized) user preference data for use in creating new accessibility themes for various impairments, and dynamically determining impairment-specific accessibility settings and themes based on analysis of anonymized user preferences. In this regard, preference data, which may also be referred to herein as “accessibility preferences” or simply “preferences,” may refer to respective values for one or more aspects of the design data (e.g., a value for a font type indicating the name of a particular font, a value for a contrast level indicating a particular contrast ratio, a value for a text box size indicating pixel dimensions, etc.).

As used herein, the terms “accessibility theme” or “theme” may refer to a collective set of content consumer preferences that together define a particular visual appearance for content that is to be displayed. Further, as used herein, the terms “accessibility template,” “accessibility theme template,” or “template” may refer to the design data (e.g., a CSS file, a JSON file, etc.) that is usable by a content producer to publish content according to a given theme.

In one aspect, the disclosed technology provides a mechanism for a content consumer to (i) configure a customized user profile including a personalized user theme that defines accessibility preferences for viewing published content (e.g., digital or printed content) and (ii) provide authorization for those accessibility preferences to be shared for purposes including (a) displaying content to the consumer, (b) recommending accessibility theme configurations based on analysis of aggregated consumer preference information, and (c) generating new accessibility themes based on analysis of aggregated consumer preference information.

In another aspect, the disclosed technology provides a mechanism for content designers to create accessibility themes based on consumer preference data. In this respect, the consumer preference data may include consumer preference data available in the accessibility hub (e.g., based on profiles and personalized themes created by content consumers using the accessibility hub), as well as consumer preference data provided to the accessibility hub by content designers based on information solicited from content consumers (e.g., information obtained during focus groups, personal interviews, etc.), among other possibilities. Such content designer-created themes may be included in the consumer preference data that is analyzed by the accessibility hub to generate recommendations for accessibility preferences and/or new accessibility themes.

In yet another aspect, the disclosed technology provides a mechanism for content producers to access accessibility theme templates that can be used by the content producers to publish their content (e.g., digitally and/or physically) in a manner that is accessible to impaired content consumers. In this respect, an accessibility theme template may take various forms. As one possibility, the accessibility theme template may comprise a user-specific accessibility theme template that is generated based on accessibility preferences associated with a given user's profile, which may be used to render content according to the given user's personalized theme. As another possibility, the accessibility theme template may comprise an impairment-specific template that is generated based on available content consumer preference data. For instance, an impairment-specific template may be created by a content designer who has access to the accessibility hub and its data, or may be generated intelligently by the accessibility hub (e.g., an artificial intelligence engine of the accessibility hub, as will be explained in more detail further below).

In yet another aspect, the disclosed technology provides a mechanism for collecting and analyzing accessibility preferences for a given cross-section of content consumers. Such a given cross-section may comprise content consumers that have indicated a given impairment, or perhaps a given combination of impairments, content consumers within a given demographic, or content consumers with one or more common accessibility preferences, among other possibilities. For instance, the accessibility hub may utilize one or more data science models that employ one or more artificial intelligence (“AI”) or machine-learning (“ML”) techniques (e.g., k-means or other clustering techniques) to classify the consumer preference data available to the accessibility hub, based on an analysis of which the accessibility hub may determine a set of accessibility preferences that may be beneficial for content consumers with a given impairment (or combination of impairments). The disclosed software technology may then involve generating theme templates and or recommendations for accessibility preferences for publishing content in a manner that is accessible to consumers with the given impairment (or combination of impairments).

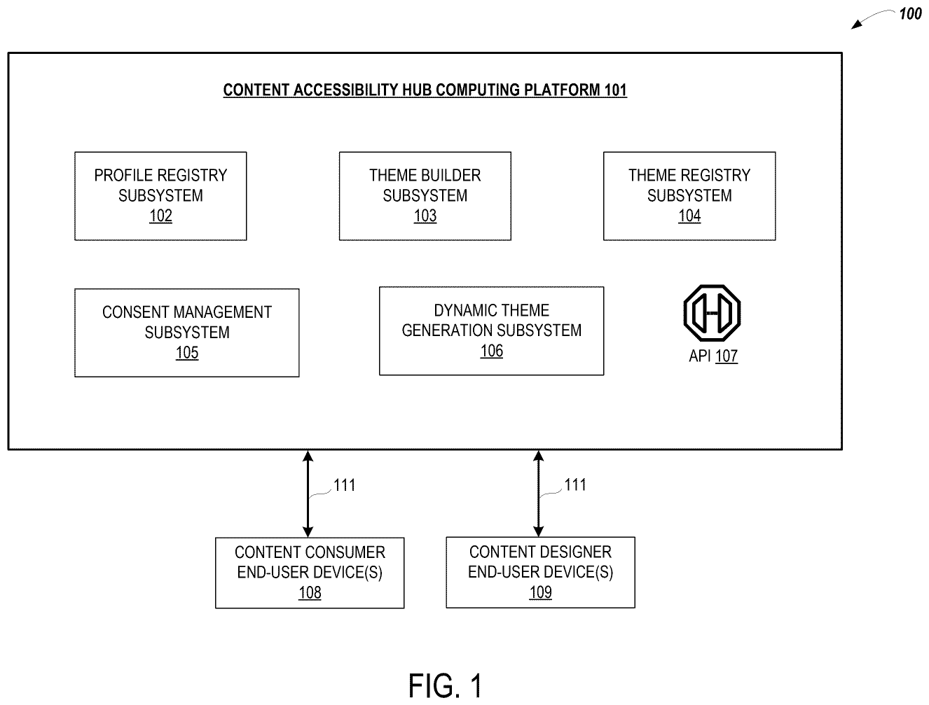

Turning now to the Figures, FIG. 1 depicts an example computing environment 100 in which example embodiments of the present disclosure may be implemented. At its core, the computing environment 100 may include an example back-end computing platform 101, which may also be referred to herein as the “content accessibility hub computing platform 101” or simply the “accessibility hub 101.” In practice, the accessibility hub 101 may generally comprise some set of physical computing resources (e.g., processors, data storage, communication interfaces, etc.) that are utilized to implement the new software technology discussed herein. This set of physical computing resources may take any of various forms. As one possibility, the accessibility hub 101 may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the accessibility hub 101 may comprise “on-premises” computing resources of the organization that operates the back-end computing platform 101 (e.g., organization-owned servers). As yet another possibility, the accessibility hub 101 may comprise a combination of cloud computing resources and on-premises computing resources. Further, as yet another possibility, the accessibility hub 101 may comprise one or more dedicated servers that have been provisioned with software for carrying out one or more of the back-end computing platform functions disclosed herein. The one or more computing resources of the accessibility hub 101 may take various other forms and be arranged in various other manners as well.

The accessibility hub computing platform 101 may comprise a collection of functional software subsystems that are each configured to perform certain of the functionality disclosed herein. These functional subsystems may take various forms.

For instance, as shown in FIG. 1, the accessibility hub 101 may comprise a profile registry subsystem 102 that is generally configured to store content consumer profile data. In this respect, the profile registry subsystem 102 may communicate with an end-user device associated with a user (e.g., a content consumer or a content designer) to facilitate creation of a user profile by causing the end-user device to present one or more user interface views that enable the user to provide user input indicating various profile information. Based on the profile information provided at the end-user device, the profile registry subsystem 102 may store profile data associated with the user. Such profile data may take various forms, including information about a content consumer, information about one or more impairments associated with the content consumer, information about accessibility themes associated with the content consumer, and information about whether or not the content consumer has consented for their accessibility preferences and/or themes to be used for purposes including theme generation and preference recommendations, which may involve sharing information about the content consumer's accessibility preferences and/or themes with other entities (e.g., a content designer or content publisher). In some implementations, where a content consumer has provided such consent, the profile registry subsystem 102 may also be responsible for issuing an access token that may be used by another entity (e.g., by a content designer or content publisher) to access to the content consumer's accessibility preferences and/or themes.

Further, the profile registry subsystem 102 may interact with one or more other subsystems of the accessibility hub 101 in order to carry out any of the functionality disclosed herein. For instance, as one example, the profile registry subsystem 102 may interact with one or both of a theme builder subsystem 103 or a theme registry subsystem 104 to provide information about a user associated with a given theme. As another example, the profile registry subsystem 102 may interact with a consent management subsystem 105 to provide information about a given user's sharing preferences. As yet another example, the profile registry subsystem 102 may interact with an API 107 in order to validate a request to access a given user's accessibility preferences. Other examples are also possible.

Further, as shown in FIG. 1, the accessibility hub 101 may comprise the theme builder subsystem 103 that is generally configured to guide users through creation of accessibility themes. In this respect, as one possibility, a user interacting with the theme builder subsystem 103 may be a content consumer with an impairment seeking to create a personalized accessibility theme that defines accessibility settings for displaying content to the user. As another possibility, the user interacting with the theme builder subsystem 103 may be a content designer seeking to create an accessibility theme that defines accessibility settings for a particular class of users (e.g., users with a given impairment, users within a given demographic, etc.) that the content designer is serving. In this respect, the theme builder subsystem 103 may communicate with an end-user device associated with a user (e.g., a content consumer or a content designer) to facilitate creation of an accessibility theme by causing the end-user device to present one or more user interface views for enabling the user to provide user input configuring various accessibility preferences for the accessibility theme. Based on the user input provided at the end-user device, the theme builder subsystem 103 may generate accessibility theme data for the accessibility theme and cause it to be stored at the accessibility hub 101. For instance, the theme builder subsystem 103 may interact with the theme registry subsystem 104 to cause storage of the accessibility theme data at the theme registry subsystem 104. The theme building subsystem 103 may interact with one or more other subsystems of the accessibility hub 101 as well.

The theme builder subsystem 103 may take various forms. As one possibility, the theme builder subsystem 103 may comprise a theme builder tool that comprises one or more user interface views that enable a user to provide information indicating at least a set of accessibility preferences for displaying content and perhaps also one or more impairments associated with the user and/or the set of accessibility preferences indicated by the user. In general, each set of accessibility preferences corresponding to a given one or more impairments may comprise a respective “accessibility theme” that can be selected to be applied to content that is to be published at a future time (e.g., published digitally or physically to a given content consumer or to content consumers with a given impairment). For instance, as one example, a content consumer may create an accessibility theme by providing user input indicating (i) the content consumer's accessibility preferences for displaying content to the content consumer and perhaps also (ii) one or more impairments associated with the content consumer and/or the accessibility preferences indicated by the content consumer. The accessibility preferences indicated by the content consumer may take various forms and in some implementations where the content consumer also indicates a type of impairment, may depend on the type of impairment indicated by the content consumer, as will be discussed in more detail further below. Further, the theme builder subsystem 103 may enable the content consumer to provide user input indicating the content consumer's consent to use their accessibility preferences for various purposes including theme generation and preference recommendations. In implementations where a content consumer indicates a set of accessibility preferences but does not indicate a particular type of impairment, the set of accessibility preferences may be used to suggest one or more relevant impairments and/or recommend a given accessibility preference, as will be explained in more detail further below. As another example, a content designer may create an accessibility theme by providing user input indicating (i) a given impairment and (ii) accessibility preferences for displaying content to content consumers having the given impairment.

Further discussion regarding designing accessible themes and creating design templates for a given theme can be found in U.S. application Ser. No. 18/478,443, incorporated by reference above.

Further yet, as shown in FIG. 1, the accessibility hub 101 may comprise the theme registry subsystem 104 that generally functions to store data about accessibility themes, including accessibility themes created via the theme builder subsystem 103 in line with the discussion above. The theme registry subsystem 104 may enable content producers to access templates for consumer-specific or impairment-specific accessibility themes that can be applied by the content producers in order to publish their content in an accessible way. In line with the discussion above, the theme registry subsystem 104 may interact with one or more other subsystems of the accessibility hub 101 to carry out various functionality disclosed herein. For instance, as one example, the theme registry subsystem 104 may interact with the theme builder subsystem 103 to obtain accessibility theme data that is to be stored at the theme registry subsystem 104. Other examples are also possible.

Further still, as shown in FIG. 1, the accessibility hub 101 may comprise a consent management subsystem 105 that generally functions to store data about content consumers'consent for sharing information about their accessibility themes and preferences for various purposes including theme generation and accessibility preference recommendations. In some implementations, where a content consumer has consented to sharing their accessibility themes and preferences, the consent management subsystem 105 may also be responsible for issuing an access token that can be used by a content designer or a content producer to access to the content consumer's accessibility themes and corresponding accessibility preferences. In this respect, issuing the access token may involve communicating with one or more other subsystems, such as the profile registry subsystem 102 to obtain information about a given content consumer that is to be included in the access token.

Further, the consent management subsystem 105 may validate requests from other users of the accessibility hub 101 to access consumer-specific preferences or themes. For example, a content producer that obtains an access token for a given content consumer (e.g., by obtaining the access token from the given consumer based on a request from the given consumer to access content published by the content producer) may request from the accessibility hub 101 a theme template for the given content consumer's preferred accessibility theme, in order to publish content for the given content consumer in accordance with the given content consumer's preferred accessibility theme. As part of the request to the accessibility hub 101, the content producer may include the access token, and the consent management subsystem 105 may validate the token and thereby verify that the content producer has approval to access the consumer-specific theme.

In line with the discussion above, the consent management subsystem 105 may interact with one or more other subsystems of the accessibility hub 101 to carry out various functionality disclosed herein. For instance, as one example, the consent management subsystem 105 may interact with the profile registry subsystem 102 in order to obtain and/or store information about a given content consumer's sharing preferences or validate a request to access a given content consumer's accessibility preferences. As another example, the consent management subsystem 105 may interact with a dynamic theme generation subsystem 106 to confirm whether or not a given content consumer has provided consent for their accessibility preferences to be used for purposes of generating accessibility preference recommendations. As yet another example, the consent management subsystem 105 may interact with the API 107 to confirm whether or not a give content consumer has provided consent to share their accessibility preferences with content producers. Other examples are also possible.

In some implementations, the consent management subsystem 105 may communicate directly with one or more end-user devices, such as an end-user device associated with a content consumer, to obtain information regarding the content consumer's sharing preferences. The consent management subsystem 105 may interact with other devices as well.

As further shown in FIG. 1, the accessibility hub 101 may comprise the dynamic theme generation subsystem 106 that generally functions to analyze accessibility theme and accessibility preference data available to the accessibility hub 101 in order to generate recommendations for accessibility themes and/or preferences. In this respect, a generated recommendation may take various forms. As one possibility, the dynamic theme generation subsystem 106 may recommend a new accessibility theme and corresponding accessibility preferences for a given impairment. In this respect, the dynamic theme generation subsystem 106 may comprise one or more AI engines that function to analyze aggregated accessibility theme and accessibility preference data that is available to the accessibility hub 101 and extract common accessibility preferences that can be applied to new accessibility themes. As another possibility, the dynamic theme generation subsystem 106 may recommend one or more accessibility preferences for inclusion in an impairment-specific theme that is being created via the theme builder subsystem 103 (e.g., recommended to a content consumer or a content designer, etc.). In this respect, the dynamic theme generation subsystem 106 may comprise one or more AI engines that function to analyze aggregated accessibility theme and accessibility preference data that is available to the accessibility hub 101and extract common accessibility preferences for accessibility themes associated with a class of user (e.g., users with a given impairment or combination of impairments, users within a given demographic, etc.). Other examples are also possible.

The accessibility hub 101 may also comprise an Application Programming Interface (“API”) 107 that may generally function to allow content producers to access the accessibility hub 101 to obtain accessibility theme templates that have been generated based on consumer-specific accessibility themes, content designer-generated accessibility themes, and/or accessibility hub-generated accessibility themes. For instance, the API 107 may respond to a call from a content producer's API for one or more accessibility templates that the content producer can use to publish content in an accessible way (e.g., for a given content consumer or for content consumers with a given impairment, etc.).

As further depicted in FIG. 1, the accessibility hub 101 may be configured to communicate with one or more end-user devices over respective communication paths 111.

The one or more end-user devices may take any of various forms, examples of which may include a desktop computer, a laptop, a netbook, a tablet, a smartphone, and/or a personal digital assistant (PDA), among other possibilities. Further, the one or more end-user devices may be associated with various types of users, including content consumers and content designers, in line with the discussion above. As shown in FIG. 1, the accessibility hub 101 may be configured to communicate with one or more content consumer end-user devices 108 and one or more content designer end-user devices 109. However, it should be understood that the accessibility hub 101 may be configured to communicate with any number of end-user devices associated with various types of users.

Each communication path 111 between the accessibility hub 101 and an end-user device 108 may generally comprise one or more communication networks and/or communications links, which may take any of various forms. For instance, each respective communication path 111 may comprise any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path 111 may be wireless, wired, or some combination thereof, and may carry data according to any of various different communication protocols. Although not shown, the respective communication paths 111 may also include one or more intermediate systems. For example, it is possible that the accessibility hub 101 may communicate with a given end-user device via one or more intermediary systems, such as a host server (not shown). Many other configurations are also possible.

Although not shown in FIG. 1, the accessibility hub 101 may also be configured to receive data from one or more external data sources that may be used to facilitate the functionality disclosed herein. For example, the accessibility hub 101 may be configured to receive accessibility theme and/or accessibility preference data from a third-party data source. For instance, in some implementations, the accessibility hub 101 may enable a user to import a pre-configured accessibility theme stored at a third-party data source, and the accessibility hub 101 may communicate with the third-party data source to obtain information about the pre-configured accessibility theme. Other examples are also possible.

Further, although not shown in FIG. 1, the accessibility hub 101 may also be configured to communicate with one or more other computing platforms, such as a back-end computing platform associated with a content producer seeking to access content consumer preferences. Other examples are also possible.

It should be understood that the computing environment 100 is one example of a computing environment in which embodiments described herein may be implemented. Numerous other arrangements are possible and contemplated herein. For instance, other computing environments may include additional components not pictured and/or more or fewer of the pictured components.

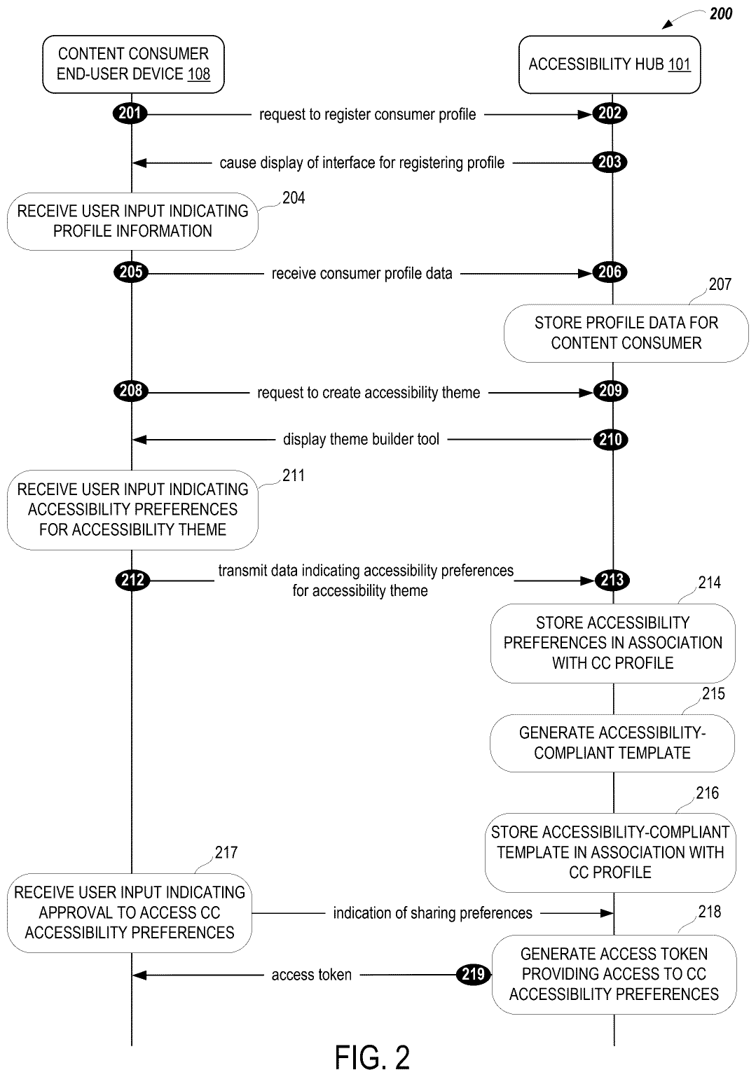

In line with the discussion above, a content consumer may interact with the accessibility hub 101 using an end-user device 108 to perform various tasks, including setting up a content consumer profile and creating an accessibility theme that indicates the content consumer's accessibility preferences. FIG. 2 depicts a flow diagram of example functionality 200 that may be carried out with respect to setting up a content consumer profile and facilitating creation of an accessibility theme. In the example of FIG. 2, the example functionality 200 may involve a content consumer end-user device, which may be the content consumer end-user device 108 (referred to in the discussion below as the “end-user device 108”) shown in FIG. 1, and a back-end computing platform, which may be the accessibility hub 101 shown in FIG. 1.

In practice, the example functionality 200 may begin with a content consumer using the end-user device 108 to access software run by the accessibility hub 101, which may take various forms in line with the discussion above, including a web application, a mobile application, or a desktop application, as some examples. In an implementation where the content consumer has not yet created a profile, the content consumer may navigate to an interface view for creating a profile, in which case, at 201, the end-user device 108 may transmit to the accessibility hub 101 a data communication indicating a request to register a user profile. At 202, the accessibility hub 101 may receive the data communication indicating the request to register a user profile. In this respect, in one embodiment, the data communication may be received by a particular subsystem of the accessibility hub 101, such as the profile registry subsystem 102.

In turn, at 203, the profile registry subsystem 102 may cause the end-user device 108 to display one or more interface views for receiving user input indicating information about the content consumer. The information about the content consumer may take various forms. As one possibility, the information about the content consumer may indicate personal information, such as information about the content consumer's name, age, or contact information. As another possibility, the information about the content consumer may indicate one or more impairments of the content consumer. In line with the discussion above, such an impairment may take any of various forms. As yet another possibility, the information about the content consumer may indicate the content consumer's consent preferences with respect to how accessibility preferences (e.g., for already-created accessibility themes or future accessibility themes) configured by the content consumer can be used. For instance, the content consumer′ consent preferences may indicate whether or not their accessibility preferences may be shared with content designers and/or content producers or whether or not their accessibility preferences may be analyzed by the accessibility hub 101. The information about the content consumer may take various other forms as well.

At 204, the end-user device 108 may receive user input collectively indicating information about the content consumer as described above. At 205, the end-user device 108 may transmit to the accessibility hub 101 a data communication comprising profile data indicating the information about the content consumer. At 206, the accessibility hub 101 (e.g., a particular subsystem such as the profile registry subsystem 102) may receive the data communication comprising the profile data. In turn, at 207, the accessibility hub 101 may cause the profile data to be stored in association with the content consumer. For instance, a particular subsystem of the accessibility hub 101, such as the profile registry subsystem 102, may cause the profile data to be stored in one or more data stores accessible to the accessibility hub 101.

In some implementations, the profile registry subsystem 102 may cause the end-user device 108 to display an indication that the content consumer has successfully created a profile. The indication may take various forms. For instance, as one possibility, the indication may comprise a visual representation of the content consumer's profile. As another possibility, the indication may comprise a notification indicating that the content consumer's profile has been created. Other examples are also possible.

After facilitating creation of the content consumer's profile as described above, or in an implementation where the content consumer has previously registered a profile, the accessibility hub 101 may cause the end-user device 108 to display one or more interface views that include options for various actions that the content consumer may take. For instance, as one possibility, the accessibility hub 101 may cause the end-user device 108 to display an option for creating an accessibility theme, which may be selectable by the content consumer to launch a theme builder tool for creating a new accessibility theme. As another possibility, the accessibility hub 101 may cause the end-user device 108 to display an option to view and/or edit information about the content consumer. As yet another possibility, the accessibility hub 101 may cause the end-user device 108 to display an option to manage an accessibility theme previously created by the content consumer. Other examples are also possible.

In any case, at some point, the content consumer may select an option to create a new accessibility theme. As mentioned above, an accessibility theme may comprise a set of accessibility preferences that dictate how content is to be displayed to the content consumer. Based on the user input, at 208, the end-user device 108 may transmit to the accessibility hub 101 a data communication indicating a request to create a new accessibility theme. At 209, the accessibility hub 101 may receive the data communication indicating the request to create the new accessibility theme. In this respect, in one embodiment, the data communication may be received by a particular subsystem of the accessibility hub 101, such as the theme builder subsystem 103. In turn, at 210, the theme builder subsystem 103 may cause the end-user device 108 to display a theme builder tool that facilitates creation of the new accessibility theme.

The theme builder tool may take various forms. For instance, as one possibility, the theme builder tool may comprise one or more user interface views that enable the content consumer to provide the user input indicating a set of accessibility preferences for the new accessibility theme.

The types of accessibility preferences that may be configured by the content consumer may take various forms, some examples of which include font-related preferences (e.g., a font type preference, a font size preference, etc.), sizing preferences (e.g., a line height preference, an embedded image size preference, etc.), spacing preferences (e.g., a line spacing preference, an element spacing preference, etc.), color preferences (e.g., a text color preference, a background color preference, a color contrast preference, etc.), or animation preferences (e.g., animation speed of dynamic elements, etc.), among many other possibilities. More information about types of accessibility preferences can be found in U.S. application Ser. No. 18/478,443, incorporated above. The accessibility theme builder tool may take other forms as well.

In one implementation, the theme builder tool may initially prompt the content consumer to indicate a given impairment (or given impairments) for which the new accessibility theme is to be created. Based on the indication, the theme builder tool may pre-configure one or more accessibility preferences in accordance with accessibility standards for the given impairment and then present the pre-configured accessibility preferences to the content consumer for further adjustment based on the content consumer's personal preferences. In this way, the theme builder tool provides a baseline set of accessibility preferences that complies with regulation standards for the given impairment while also providing the content consumer with the flexibility to make additional modifications to the standard-compliant accessibility preferences in line with their own personal preferences.

In another implementation, the theme builder tool may compare accessibility preferences provided by the content consumer against accessibility compliance standards (e.g., WCAG 2.1 level AA, etc.) for the given impairment and then notify the content consumer about any preferences that do not comply with the accessibility compliance standards, perhaps along with information about the compliance requirements for each non-compliant preference.

In yet another implementation, the theme builder tool may present the content consumer with one or more generalized accessibility themes based on an indicated impairment that the content consumer can opt to select as the new accessibility theme.

Other examples are also possible.

As mentioned above, the theme builder tool may be used to configure accessibility preferences for both digital and physical content. In some instances, a content consumer's accessibility preferences may require adjustment if the content is to be consumed physically (i.e., printed on a physical artifact). For instance, a given artifact on which content is to be printed (e.g., a credit card, a driver's license, etc.) may have one or more design values (e.g., a particular background color for a given type of credit card issued by a given credit card provider, etc.) that would require one or more accessibility settings to be adjusted so that content is still accessible to the content consumer in a manner that is consistent with the content consumer's accessibility preferences. In this respect, in one implementation, the theme builder tool may enable the content consumer to provide input indicating a content publication type—i.e., whether the accessibility theme is to be applied to digital content or printed content, based on which the theme builder tool may either prompt the content consumer to adjust, or automatically adjust, one or more accessibility settings such that they conform with both applicable accessibility compliance standards and the content consumer's accessibility preferences, in line with the discussion above.

In any event, at 211, the end-user device 108 may, via the theme builder tool, receive user input indicating a set of accessibility preferences for the new accessibility theme. Based on the user input configuring the accessibility preferences for the new accessibility theme, at 212, the end-user device 108 may transmit to the accessibility hub 101 a data communication indicating the set of accessibility preferences for the new accessibility theme, perhaps also along with information about a given impairment associated with the new accessibility theme. At 213, the accessibility hub 101 may receive the data communication, and in turn, at 214, cause the accessibility preferences to be stored in association with the content consumer's profile. In this respect, in one embodiment, the accessibility preferences may be stored at a particular subsystem of the accessibility hub 101. For instance, the accessibility preferences may be stored in one or more data stores of the profile registry subsystem 102 as mentioned above.

Thereafter, at 215, the accessibility hub 101 may generate an accessibility-compliant template comprising a set of accessibility-compliant design data corresponding to the content consumer's accessibility preferences. The accessibility-compliant template may take the form of a cascading style sheet (CSS) file or a JavaScript object notation (JSON) file, among other possibilities. In this regard, the theme builder subsystem 103 of the accessibility hub 101 may utilize a set of accessibility-aware design services (e.g., accessed via a respective API) in conjunction with the content consumer's accessibility preferences to define the various components of the design data in a way that is compliant with a given accessibility standard, as discussed in U.S. application Ser. No. 18/478,443 incorporated above. In one implementation, the accessibility hub 101 may implement a continuous integration and continuous delivery/deployment (CI/CD) framework such that any changes made to the accessibility-compliant template are automatically pushed out to relevant entities so that the changes will be reflected in content that is to be consumed by the content consumer. For instance, based on an update to the accessibility-compliant template, the accessibility hub 101 may automatically provide updated design data to a content provider with which the content consumer has consented to share accessibility preferences so that the content provider has the most current version of the content consumer's accessibility preferences.

At 216, after the accessibility-compliant design data is generated, it may be stored as a template for the given accessibility theme, in association with the content consumer who provided the accessibility preferences for the new accessibility theme. In this respect, in one embodiment, the accessibility-compliant template may be stored at a particular subsystem of the accessibility hub 101. For instance, the accessibility-compliant template for the given accessibility theme may be stored in one or more data stores of the theme registry subsystem 104.

After providing the accessibility preferences used to create the accessibility theme as described above, the content consumer may request to view content that is displayed in accordance with the accessibility theme. In this respect, in an implementation where the accessibility theme is a personalized accessibility theme (e.g., the content consumer has made additional modifications to a standard-compliant accessibility preferences) and the content consumer has consented to sharing their accessibility preferences with content producers, the accessibility hub 101 may generate and issue an access token that is to be included in a request to view content on behalf of the content consumer at a future time when the content consumer wishes to view content. In general, the access token may include information identifying the content consumer that is to be used for verifying the request, along with an indication of the accessibility theme that is to be used for obtaining the content consumer's accessibility preferences. The access token may take other forms as well.

The content consumer may indicate their consent preferences at various times, such as at the time of profile creation, at the time of creating an accessibility theme, or after creating an accessibility theme, among other possibilities. Further, the content consumer may interact with the profile registry subsystem 102 and/or the consent management subsystem 105 at various times via an end-user device 108 in line with the discussion above to update their consent preferences. In any case, in an instance where the content consumer wishes to provide consent for their accessibility preferences to be used for the purposes described herein, the content consumer may navigate to an interface view for configuring consent preferences. In this respect, the content consumer may utilize the end-user device 108 to interact with the profile registry subsystem 102 or the consent management subsystem 105, which may cause the end-user device 108 to display one or more interface views for receiving user input indicating whether or not the content consumer provides consent for (i) other entities, such as content designers, content producers, and/or other content consumers, etc., that may interact with the accessibility hub 101 to access the content consumer's accessibility preferences, or (ii) the accessibility hub 101 to include the content consumer's accessibility preferences in analyses performed by the accessibility hub 101.

For instance, at 217, the end-user device 108 may receive user input indicating that the content consumer has provided consent for other entities to access the content consumer's accessibility preferences. The end-user device 108 may then transmit to the accessibility hub 101 a data communication indicating the content consumer's consent preferences. In turn, at 218, the accessibility hub 101 may generate an access token that can be used (e.g., by a content producer or a content designer) to verify permission to access the content consumer's accessibility preferences.

At 219, the accessibility hub 101 may transmit the access token to the end-user device 108. The access token may then be provided to a content producer (e.g., by updating sharing preferences in a respective user account for the content consumer provided the content producer, etc.) when requesting content that is to be displayed to the content consumer. In turn, the content producer may utilize the access token to obtain information about the content consumer's accessibility preferences from the accessibility hub 101, as will be discussed further below.

In line with the discussion above, the accessibility hub 101 may be accessed by different types of users for various purposes. For instance, the accessibility hub 101 may be accessed by a content designer who is responsible for designing content that will be published digitally or physically (e.g., printed) in order to create an accessibility theme for a given impairment based on consumer preference data collected by the content designer, such as through personal interviews, surveys, focus groups, etc.

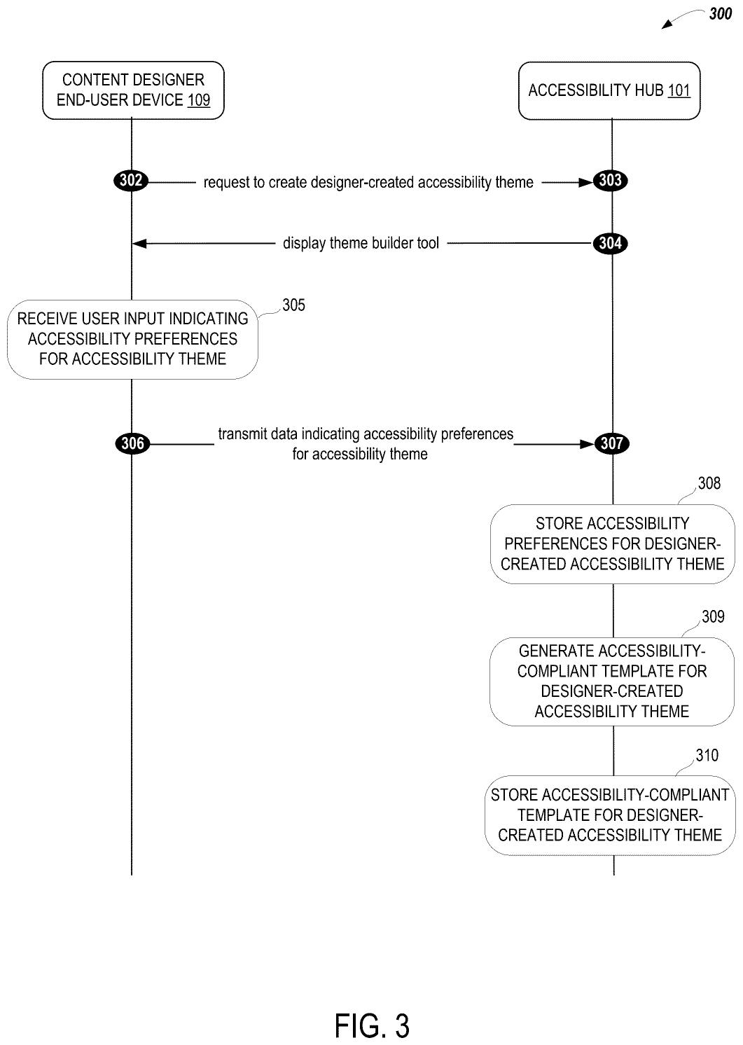

FIG. 3 depicts an example functionality 300 for facilitating configuration of accessibility preferences by a content designer who is responsible for designing content that is to be consumed by content consumers. In this respect, the content designer may be responsible for designing web-based content that will be published digitally or content that will be published physically (e.g., printed) and may wish to create one or more accessibility themes that can be applied to various content in order to make the content accessible to impaired content consumers.

As shown in FIG. 3, the example functionality 300 may involve a content designer end-user device, which may be the content designer end-user device 109 shown in FIG. 1, and a back-end computing platform, which may be the accessibility hub 101 shown in FIG. 1. The example functionality 300 may begin at 302, with the end-user device 109 transmitting to the accessibility hub 101 a data communication indicating a request on behalf of the content designer to create a new accessibility theme. In practice, the content designer may utilize the end-user device 109 to access software (e.g., a software application such as a desktop or mobile software application) incorporating the disclosed technology run by the accessibility hub 101. In some embodiments, the content designer may begin with registering a content designer profile in line with the discussion of FIG. 2 above with respect to 201-207. In any case, to create a new accessibility theme, the content designer may navigate to a view for creating accessibility themes and then select an option to create a new accessibility theme, such as an option to launch the theme builder tool described above.

At 303, the accessibility hub 101 may receive the data communication comprising the request to create the accessibility theme. In this respect, the data communication may be received by a particular subsystem of the accessibility hub 101, such as the theme builder subsystem 103. In turn, at 304, the accessibility hub 101 (i.e., the theme builder subsystem 103) may cause the end-user device 109 to display the theme builder tool for creating the new accessibility theme. In line with the discussion above, the theme builder tool may comprise one or more interface views that enable the content designer to provide user input indicating a set of accessibility preferences for the new accessibility theme, and the types of accessibility preferences that may be configured by the content designer may take any of the various forms described above, including font-related preferences (e.g., a font type preference, a font size preference, etc.), sizing preferences (e.g., a line height preference, an embedded image size preference, etc.), spacing preferences (e.g., a line spacing preference, an element spacing preference, etc.), color preferences (e.g., a text color preference, a background color preference, a color contrast preference, etc.), or animation preferences (e.g., animation speed of dynamic elements, etc.), among many other possibilities. More information about types of accessibility preferences can be found in U.S. application Ser. No. 18/478,443, incorporated above. The theme builder tool may take other forms as well.

In one implementation, the theme builder tool may initially prompt the content designer to indicate a given impairment (or given impairments) for which the new accessibility theme is to be created. Based on the indication, the theme builder tool may pre-configure one or more accessibility preferences in accordance with accessibility standards for the given impairment(s) and then present the pre-configured accessibility preferences to the content designer for further adjustment based on the consumer accessibility preference data collected by the content designer. In another implementation, the theme builder tool may compare accessibility preferences provided by the content designer against accessibility compliance standards (e.g., WCAG 2.1 level AA, etc.) for the given impairment and then notify the content designer any preferences that do not comply with the accessibility compliance standards, perhaps along with information about the compliance requirements for each non-compliant preference. In yet another implementation, the theme builder tool may present the content designer with one or more generalized accessibility themes based on an indicated impairment that the content designer can opt to select as the new accessibility theme. Other examples are also possible.

In any case, the theme builder tool may guide the content designer through a series of prompts that enable the content designer to provide various accessibility preferences for the new accessibility theme. After the content designer has provided user input for each required prompt, the theme builder tool may provide an option to save the indicated accessibility preferences in the form of a new accessibility theme.

In line with the discussion above, in one implementation, the theme builder tool may enable the content designer to provide input indicating a content publication type, based on which the theme builder tool may either prompt the content designer to adjust, or automatically adjust, one or more accessibility settings such that they conform with applicable accessibility compliance standards.

At 305, the end-user device 108 may, via the theme builder tool, receive user input indicating a set of accessibility preferences for the new accessibility theme. Based on the user input configuring the accessibility preferences for the new content designer-created accessibility theme, at 306, the end-user device 109 may transmit to the accessibility hub 101 (i.e., the theme builder subsystem 103) a data communication indicating the set of accessibility preferences for the new content designer-created accessibility theme, perhaps also along with information about a given impairment associated with the new accessibility theme. At 307, the accessibility hub 101 may receive the data communication, and in turn, at 308, store the accessibility preferences in association with the new content designer-created accessibility theme. In this respect, in one embodiment, the accessibility preferences may be stored at a particular subsystem of the accessibility hub 101. For instance, the accessibility preferences may be stored in one or more data stores of the theme registry subsystem 104.

The accessibility theme created by the content designer may then be used for various purposes, including dynamic generation of new accessibility themes and/or recommendations for accessibility preferences.

In this respect, at 309, the accessibility hub 101 may generate an accessibility-compliant template comprising a set of accessibility-compliant design data corresponding to the accessibility preferences indicated in the new content designer-created accessibility theme. The accessibility-compliant template may take the form of a cascading style sheet (CSS) file or a JavaScript object notation (JSON) file, among other possibilities. In line with the discussion above, the theme builder subsystem 103 of the accessibility hub 101 may utilize a set of accessibility-aware design services (e.g., accessed via a respective API) in conjunction with the accessibility preferences indicated in the new content designer-created accessibility theme to define the various components of the design data in a way that is compliant with a given accessibility standard, as discussed in U.S. application Ser. No. 18/478,443 incorporated above. At 310, after the accessibility-compliant design data is generated, it may be stored as a template for the given accessibility theme. In this respect, in one embodiment, the accessibility-compliant template may be stored at a particular subsystem of the accessibility hub 101, such as at one or more data stores of the theme registry subsystem 104.

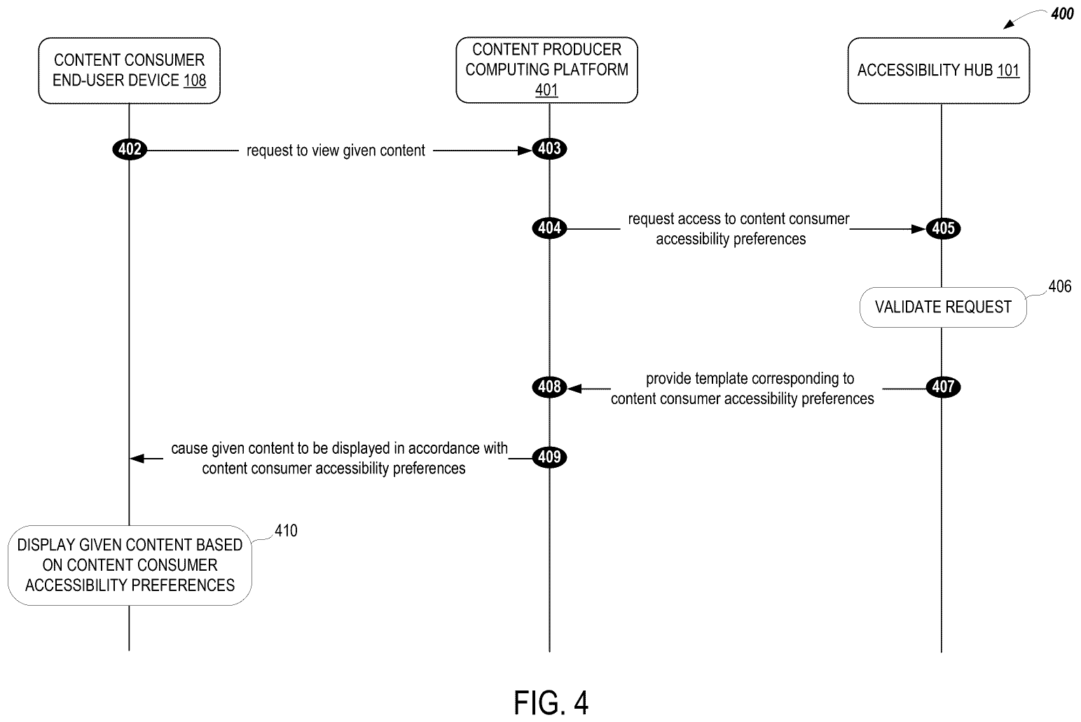

In line with the discussion above, accessibility themes stored at the accessibility hub 101 may be accessed by content producers seeking to publish content in an accessible way. FIG. 4 depicts an example functionality 400 for providing an accessibility-compliant template to a content producer in order for publishing web-based content in accordance with an accessibility theme configured by a content consumer in line with the discussion above. As shown in FIG. 4, the example functionality 400 may involve the content consumer end-user device 108, a content producer computing platform 401, and the accessibility hub 101. The content producer computing platform 401 may be responsible for publishing web-based content that is displayed by end-user devices associated with content consumers, such as the end-user device 108.

The example functionality 400 may begin at 402, with the end-user device 108 transmitting to the content producer computing platform 401 a data communication comprising a request on behalf of a given content consumer to view given content. In practice, the given content consumer may use the end-user device 108 to browse web-based content and may navigate to a web page operated by the content producer computing platform 401. In line with the discussion above, in some implementations where the given content consumer has configured a personalized accessibility theme and consented to sharing the personalized accessibility theme with content producers, the request to view the given content may include an access token that identifies the given content consumer and indicates the accessibility theme based on which the given content is to be displayed.

At 403, the content producer computing platform 401 may receive the request to view the given content. In turn, at 404, the content producer computing platform 401 may transmit to the accessibility hub 101 a request to access the given content consumer's accessibility preferences. The request may include the access token received from the end-user device 108 that indicates permission for the content producer computing platform 401 to access the given content consumer's accessibility preferences and is to be used by the accessibility hub 101 to validate the access request.

At 405, the accessibility hub 101 may receive the access request from the content producer computing platform 401. In this respect, the access request may be received by the API 107 of the accessibility hub 101, which may communicate with one or more other subsystems of the accessibility hub 101 to facilitate validation of the access request. For instance, the API may communicate with a subsystem of the accessibility hub 101 that issued the access token, such as the profile registry subsystem 102 or the consent management subsystem 105, in line with the discussion above, to verify that the given content consumer has consented to sharing their accessibility preferences with content producers.

At 406, the accessibility hub 101 may determine, via the profile registry subsystem 102 or the consent management subsystem 105, that the access request is valid.

Based on determining that the access request is valid, at 407, the accessibility hub 101 may transmit to the content producer computing platform 401 a data communication comprising the accessibility-compliant theme template, which may involve interacting with the theme registry subsystem 104 to obtain the accessibility-compliant template for displaying content in accordance with the given content consumer's accessibility preferences. At 408, the content producer computing platform 401 may receive the accessibility-compliant theme template for displaying content in accordance with the given content consumer's accessibility preferences.

In some implementations, the functionality described above with respect to 404-408 may be performed prior to the content producer computing platform 401 receiving the request to view the given content. For instance, in line with the discussion above with respect to 217-219 of FIG. 2, after receiving the access token from the accessibility hub 101, the content consumer end-user device 108 may provide the access token to the content producer computing platform 401. For example, the content consumer may utilize the end-user device 108 to access a user account associated with the content consumer run by the content producer computing platform 401 and provide user input indicating that the content consumer has granted permission for the content producer computing platform 401 to access the content consumer's accessibility preferences stored at the accessibility hub 101. In turn, the content producer computing platform 401 may interact with the accessibility hub 101 to request one or more accessibility-compliant templates associated with the content consumer in line with the discussion above. Thereafter, when the content producer computing platform 401 receives a request on behalf of the given content consumer to view content, the content producer computing platform 401 may publish the content based on the previously-obtained accessibility-compliant template(s). The content producer computing platform 401 may obtain an accessibility-compliant template associated with a given content consumer at other times as well.

At 409, after receiving the accessibility-compliant theme template associated with the given content consumer, the content producer computing platform 401 may cause the given content to be displayed in accordance with the given content consumer's accessibility preferences. For instance, as one possibility, the content producer computing platform 401 may publish an instance of the given content based on the accessibility-compliant theme template that can then be displayed by the end-user device 108. Other examples are also possible. Thereafter, at 410, the end-user device 108 may display the published instance of the given content in accordance with the accessibility theme configured by the given content consumer (e.g., as described above with respect to FIG. 1).

Advantageously, in the way described above, the disclosed software technology enables a content consumer to configure an accessibility theme that can be applied to content that the content consumer will view prior to the content being published, thereby reducing the need for the content consumer to manually configure accessibility settings that are to be applied retroactively to published content in an attempt to make the published content accessible.

In some implementations, one or more aspects of the functionality 400 described above may not involve an access token. For instance, in line with the discussion above, the given content consumer may have selected a generalized accessibility theme to serve as their accessibility theme, instead of customizing accessibility preferences. In such an instance, because no access to customized accessibility preferences is needed, the content producer computing platform 401 would not need to be validated by the accessibility hub 101 in order to access the given content consumer's accessibility preferences. Further, in some implementations, the given content consumer may not even have an associated profile, in which case the given content consumer may only be able to select generalized accessibility preferences, which would not require the content producer computing platform 401 to validate access via an access token. Further yet, in other implementations, the content producer computing platform 401 may request accessibility-compliant templates for generalized accessibility themes (e.g., generalized accessibility themes generated by the accessibility hub 101 as will be described below, generalized accessibility themes created by content designers as described above, etc.) that do not require a content producer computing platform 401 to validate access. Other examples are also possible.

Furthermore, one or more aspects of the functionality 400 described above may be carried out (with or without an access token) in order to obtain one or more accessibility-compliant templates for use in publishing content in some sort of physical form. Such content may take an of various forms, including those previously described above, such as credit cards, identification cards, correspondence, promotional materials, informational materials, academic materials, professional materials, among many other possibilities.

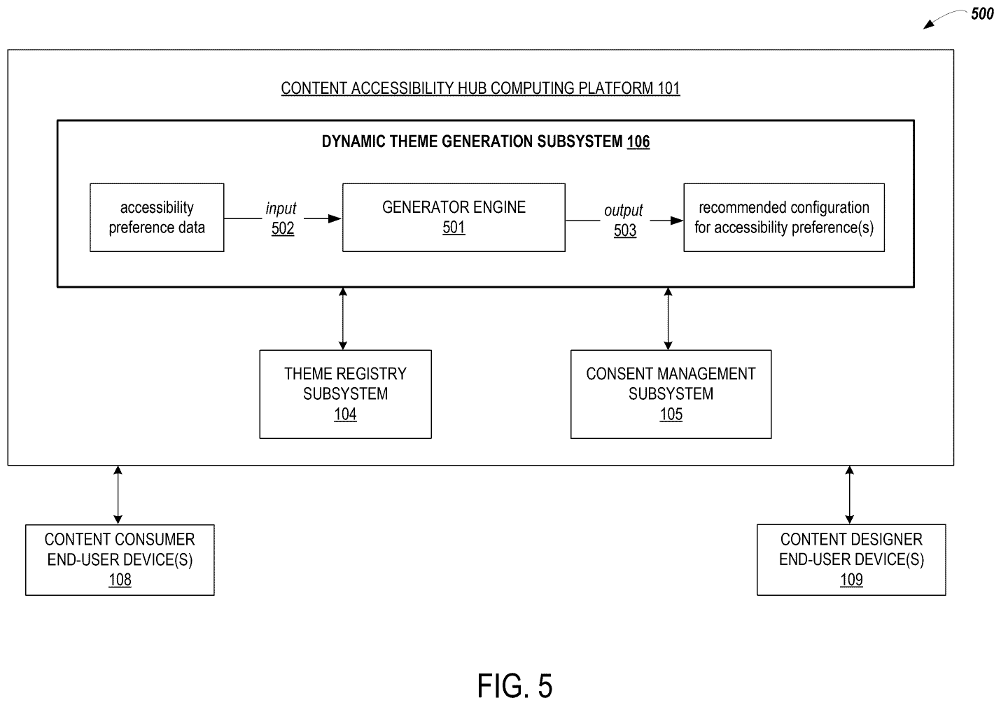

As mentioned above, accessibility themes comprising accessibility preferences for various impairments stored at the accessibility hub 101 may be analyzed for purposes including generating new accessibility themes and/or recommendations for accessibility preferences. Such analysis may be carried out by one or more subsystems of the accessibility hub 101. For instance, in one implementation, the analysis may be carried out by the dynamic theme generation subsystem 106. FIG. 5 depicts a diagram 500 of structural components of the dynamic theme generation subsystem 106 in accordance with one embodiment of the disclosed technology.

As shown in FIG. 5, the example dynamic theme generation subsystem 106 may comprise a generator engine 501 that is configured to (i) receive, as input 502, accessibility preference data and (ii) generate, as output 503, a set of one or more recommended accessibility preferences (e.g., values for one or more aspects of the design data to be used to render content).

The input 502 may take various forms. As one possibility, the input 502 may comprise accessibility preferences data based on user input provided by content consumers who have created accessibility themes in the accessibility hub 101 and have consented to sharing their accessibility preferences for analysis. As another possibility, the input 502 may comprise accessibility preference data based on user input provided by one or more content designers who have created accessibility themes in the accessibility hub 101. As yet another possibility, the input 502 may comprise a subset of the accessibility preference data available in the accessibility hub 101. In this respect, the subset may be determined based on one or more parameters provided by a user that define a scope for the input 502. Further still, as another possibility, the input 502 may comprise all accessibility preference data available in the accessibility hub 101.

The input 502 that is provided to the generator engine 501 may be defined based on one or more parameters, which may take various forms. For instance, as one possibility, the one or more parameters may comprise a given impairment. For example, to create a new colorblindness-related accessibility theme, the input 502 may be configured to include accessibility preferences data for all colorblindness-related themes available to the accessibility hub 101. As another possibility, the one or more parameters may comprise a given accessibility preference, irrespective of any particular impairment. For example, the input 502 may comprise accessibility preferences data for all themes available to the accessibility hub 101 that indicate a “dark mode” accessibility preference, perhaps in response to determining that a content designer utilizing the dynamic theme generation subsystem 106 has input a selection for generating a new accessibility theme that includes a “dark mode” preference. As yet another possibility, the one or more parameters may comprise a consumer demographic. For example, the input 502 may comprise accessibility preferences data for all themes available to the accessibility hub 101 that are associated with a particular consumer demographic (e.g., age, impairment, etc.). Many other examples are possible.

In some implementations where the input 502 comprises a subset of all accessibility preference data available to the accessibility hub 101, the dynamic theme generation subsystem 106 may communicate with one or more other subsystems to determine the input 502. For instance, as one example, the dynamic theme generation subsystem 106 may communicate with the profile registry subsystem 102 to obtain information about content consumer demographics in order to analyze accessibility preference data for a particular content consumer demographic. As another example, the dynamic theme generation subsystem 106 may communicate with the theme registry subsystem 104 to obtain information about impairments associated with accessibility themes available to the accessibility hub 101 in order to analyze accessibility preference data corresponding to a particular impairment. Other examples are also possible.

The input 502 may take other forms as well, including a combination of any one or more of the variations described above.

The output 503 may take various forms. As one possibility, the output 503 may take the form of a set of accessibility preferences comprising a new accessibility theme. For instance, as one example, the generator engine 501 may analyze accessibility preference data corresponding to a set of accessibility themes associated with a particular impairment, such as dyslexia or motion sensitivity. In doing so, the generator engine 501 may identify certain commonalities amongst accessibility preferences within the set of accessibility themes. For instance, the generator engine may determine that themes associated with dyslexia tend to have a particular font type, or a contrast ratio that is above a particular level. Based on the analysis, the generator engine 501 may generate a “dyslexia” accessibility theme template comprising accessibility preferences based on the identified commonalities, which may then be saved as a new accessibility theme. As another possibility, the output 503 may take the form of a recommended accessibility preference. For instance, as one example, a user of the accessibility hub 101 may utilize the theme builder subsystem 103 to manually create a new accessibility theme for dyslexia. During this creation, the theme builder 103 might suggest that a given preference (e.g., a particular font type) is often selected in other dyslexia themes. Other examples are also possible.

The generator engine 501 may comprise one or more AI engines and/or one or more data science models that are configured to analyze accessibility preferences data and derive insights from the data. As one example, the generator engine 501 may derive information about identified commonalities amongst previously created accessibility themes, and then output a recommendation for one or more accessibility preferences based on the identified commonalities. The generator engine 501 may identify commonalities amongst the accessibility preferences in various ways. For instance, as one possibility, the generator engine 501 may identify a commonality amongst the accessibility preferences based on determining that a threshold number of content consumers (e.g., a threshold number of content consumers in a given demographic, such as half of the content consumers or more) selected a same preference. As another example, the generator engine 501 may identify a commonality amongst the accessibility preferences based on a given impairment associated with a set of accessibility preferences. Other examples are also possible.

The generator engine 501 may take other forms as well.

The generator engine 501 may be run at various times. For instance, as one possibility, the generator engine 501 may be run based on the accessibility hub 101 receiving, from an end-user device 108, a request on behalf of a content consumer to register a profile (e.g., based on information about the content consumer provided during profile registration). As another possibility, the generator engine 501 may be run based on the accessibility hub 101 receiving, from an end-user device 108 or an end-user device 109, a request on behalf of a content consumer or a content designer to create an accessibility theme (e.g., based on an indicated impairment). As yet another possibility, the generator engine 501 may be run based on the accessibility hub 101 receiving, from an end-user device 108 or an end-user device 109, an indication of a given accessibility preference for an accessibility theme. Further, as another possibility, the generator engine 501 may be run based on the accessibility hub 101 receiving, from an end-user device 109 or a content producer computing platform 401, a request on behalf of a content designer or a content producer to obtain an accessibility theme template (e.g., based on information indicating a given impairment, a given accessibility preference configuration, a given consumer demographic, etc.). Other examples are also possible.

After generating an output 503, the accessibility hub 101 may take some further action, which may take various forms. For instance, as one possibility, the accessibility hub 101 may cause an end-user device to display an indication based on the output 503. For example, in an instance where the output 503 was generated during a content consumer's profile setup, the accessibility hub 101 may cause an end-user device 109 associated with the content consumer to display a respective visual representation of one or more accessibility theme template recommendations that were generated by the generator engine 501.

As another possibility, the accessibility hub 101 may generate an accessibility theme template for provision to a third-party computing platform. For example, in an instance where the output 503 was generated in response to a request from a content producer computing platform to obtain a given accessibility-compliant theme template (e.g., an impairment-specific accessibility theme template, a consumer-specific impairment theme template, etc.), the accessibility hub 101 may generate a template file (e.g., CSS, JSON, etc.) comprising accessibility preferences for the accessibility theme and cause the template to be provided to the content producer computing platform so that the content producer is able to publish content in accordance with the given accessibility theme.

The accessibility hub 101 may take other actions as well.

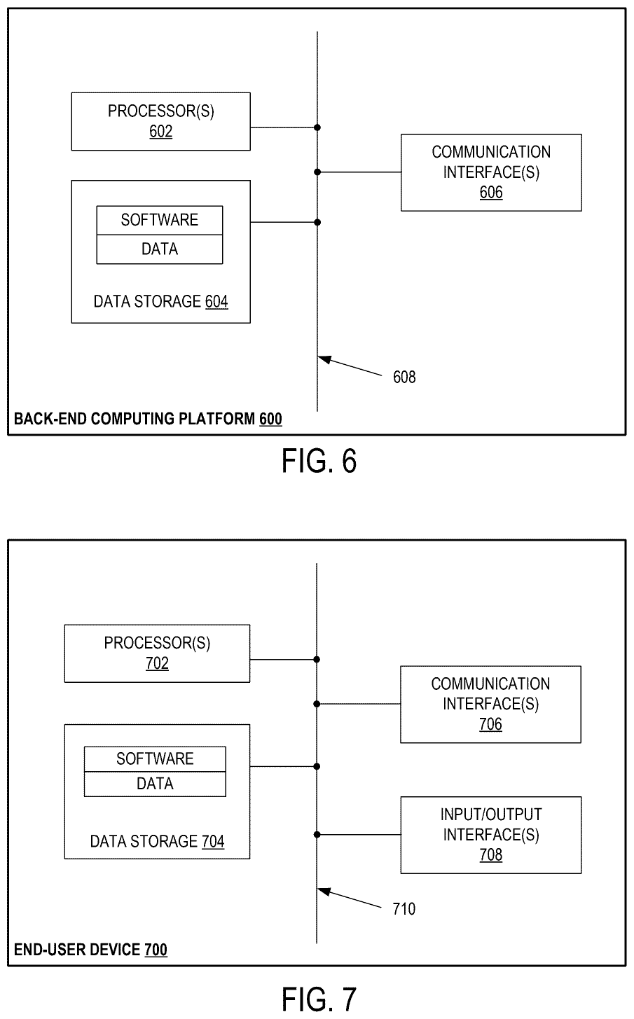

Turning now to FIG. 6, a simplified block diagram is provided to illustrate some structural components that may be included in an example back-end computing platform 600 that may be configured to carry out any of the various back-end platform functions disclosed herein. At a high level, the example back-end computing platform 600 may generally comprise any one or more computing systems that collectively include one or more processors 602, data storage 604, and one or more communication interfaces 606, all of which may be communicatively linked by a communication link 608 that may take the form of a system bus, a communication network such as a public, private, or hybrid cloud, or some other connection mechanism. Each of these components may take various forms.

The one or more processors 602 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. It should also be understood that the one or more processors 602 could comprise processing components that are distributed across a plurality of physical computing systems connected via a network.

In turn, the data storage 604 may comprise one or more non-transitory computer-readable storage mediums that are collectively configured to store (i) program instructions that are executable by one or more processors 602 such that the back-end computing platform 600 is configured to perform any of the various functions disclosed herein, including but not limited to any of the back-end-platform functions disclosed herein, and (ii) data that may be received, derived, or otherwise stored, for example, in one or more databases, file systems, repositories, or the like, by the back-end computing platform 600, in connection with performing any of the various back-end platform functions disclosed herein. In this respect, the one or more non-transitory computer-readable storage mediums of the data storage 604 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. It should also be understood that the data storage 604 may comprise computer-readable storage mediums that are distributed across a plurality of physical computing systems connected via a network.

The one or more communication interfaces 606 may be configured to facilitate wireless and/or wired communication with other systems and/or devices. Additionally, in an implementation where the back-end computing platform 600 comprises a plurality of physical computing systems connected via a network, the one or more communication interfaces 606 may be configured to facilitate wireless and/or wired communication between these physical computing systems (e.g., between computing and storage clusters in a cloud network). As such, the one or more communication interfaces 606 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 600 may additionally include or have an interface for connecting to one or more user-interface components that facilitate user interaction with the back-end computing platform 600, such as a keyboard, a mouse, a trackpad, a display screen, a touch-sensitive interface, a stylus, a virtual-reality headset, and/or one or more speaker components, among other possibilities.

It should be understood that the back-end computing platform 600 is one example of a computing platform that may be used with the embodiments described herein. Numerous other arrangements are possible and contemplated herein. For instance, in other embodiments, the back-end computing platform 600 may include additional components not pictured and/or more or fewer of the pictured components.

Turning next to FIG. 7, a simplified block diagram is provided to illustrate some structural components that may be included in an example end-user device 700 that may be configured to carry out any of the various functions disclosed herein, including but not limited to any of the various end-user device functionality discussed above, including any functionality carried out by a content consumer end-user device or a content designer end-user device. As shown in FIG. 7, the end-user device 700 may include one or more processors 702, data storage 704, one or more communication interfaces 706, and one or more input/output (I/O) interfaces 708, all of which may be communicatively linked by a communication link 710 that may take the form of a system bus or some other connection mechanism. Each of these components may take various forms.

The one or more processors 702 may comprise one or more processing components, such as general-purpose processors (e.g., a single-or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 704 may comprise one or more non-transitory computer-readable storage mediums that are collectively configured to store (i) program instructions that are executable by the processor(s) 702 such that the end-user device 700 is configured to perform any of the end-user device functions disclosed herein, and (ii) data that may be received, derived, or otherwise stored, for example, in one or more databases, file systems, repositories, or the like, by the end-user device 700. In this respect, the one or more non-transitory computer-readable storage mediums of the data storage 704 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 704 may take other forms and/or store data in other manners as well.

The one or more communication interfaces 706 may be configured to facilitate wireless and/or wired communication with other computing devices. The communication interface(s) 706 may take any of various forms suitable to provide for any of various types of wireless communication (e.g., Wi-Fi communication, cellular communication, short-range wireless protocols, etc.) and/or wired communication. Other configurations are possible as well.

The end-user device 700 may additionally include or have interfaces for one or more I/O interfaces 708 that can be used to facilitate user interaction with the end-user device 700, such as a keyboard, a mouse, a trackpad, a display screen, a touch-sensitive interface, a stylus, a virtual-reality headset, and/or one or more speaker components, among other possibilities.

It should be understood that the end-user device 700 is one example of an end-user device that may be used to interact with an example computing platform as described herein. Numerous other arrangements are possible and contemplated herein. For instance, in other embodiments, the end-user device 700 may include additional components not pictured and/or more or fewer of the pictured components.

### Conclusion

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. Claims should not be construed as requiring action by such actors unless explicitly recited in claim language.

1. A computing platform comprising:
at least one processor;
at least one non-transitory computer-readable medium; and
program instructions stored on the at least one non-transitory computer-readable medium that are executable by the at least one processor such that the computing platform is configured to:
receive, from a computing device associated with a given user, a request to create an accessibility theme for viewing digital content;
cause the computing device to display a series of user interface views that enable the given user to provide user input configuring the accessibility theme;
receive, from the computing device, data indicating a set of accessibility preferences that define how digital content is to be published for display to the given user according to the accessibility theme;
cause storage of profile data in association with the given user, the profile data indicating the set of accessibility preferences that define how content is to be published for display to the given user according to the accessibility theme;
receive, from the computing device, data indicating user authorization to share the set of accessibility preferences with one or more content producers;
based on receiving the data indicating the user authorization, transmit, to the computing device, an access token for accessing the set of accessibility preferences;
after transmitting the access token to the computing device, receive, from a content producer computing platform, a request for the set of accessibility preferences, the request comprising the access token; and
based on receiving the request for the set of accessibility preferences comprising the access token, transmit the set of accessibility preferences to the content producer computing platform.

2. The computing platform of claim 1, further comprising program instructions that are executable by the at least one processor such that the computing platform is configured to:
receive, from the computing device, an indication of a given user impairment, wherein the profile data further comprises data indicating the given user impairment.

3. The computing platform of claim 1, further comprising program instructions that are executable by the at least one processor such that the computing platform is configured to:
based on receiving the data indicating the user authorization to share the set of accessibility preferences with one or more content producers, generate the access token; and
before transmitting the set of accessibility preferences to the content producer computing platform, validate the access token received from the content producer computing platform.

4. The computing platform of claim 1, further comprising program instructions that are executable by the at least one processor such that the computing platform is configured to:
based on the set of accessibility preferences, generate a template comprising accessibility-compliant design data that is usable by the content producer computing platform for publishing content according to the accessibility theme; and
wherein the program instructions that are executable by the at least one processor such that the computing platform is configured to transmit the set of accessibility preferences to the content producer computing platform comprises program instructions that are executable by the at least one processor such that the computing platform is configured to:
transmit the template to the content producer computing platform.

5. The computing platform of claim 4, wherein the template comprises a cascading style sheet (CSS) file or a JavaScript object notation (JSON) file.

6. The computing platform of claim 1, wherein:
the computing device is a first computing device;
the given user is a first user;
the set of accessibility preferences is a first set of accessibility preferences;
the accessibility theme is a first accessibility theme; and
the computing platform further comprises program instructions that are executable by the at least one processor such that the computing platform is configured to:
receive, from a second computing device associated with a second user, data indicating a second set of accessibility preferences that define how digital content is to be published for display to the second user according to a second accessibility theme;
cause storage of profile data in association with the second user, the profile data indicating the second set of accessibility preferences that define how content is to be published for display to the second user according to the second accessibility theme; and
based on at least (i) the first set of accessibility preferences and (ii) the second set of accessibility preferences, generate a new set of accessibility preferences that define how content is to be published for display according to a new accessibility theme.

7. The computing platform of claim 6, wherein the program instructions that are executable by the at least one processor such that the computing platform is configured to generate the new set of accessibility preferences that define how content is to be published for display according to the new accessibility theme comprise program instructions that are executable by the at least one processor such that the computing platform is configured to:
utilize one or more machine learning models to determine, from respective sets of accessibility preferences for a plurality of users, one or more user preference commonalities, wherein the new set of accessibility preferences comprise the one or more user preference commonalities.

8. The computing platform of claim 6, further comprising program instructions that are executable by the at least one processor such that the computing platform is configured to:
receive, from the content producer computing platform, a request for the new set of accessibility preferences, wherein the request does not comprise the access token; and
based on receiving the request for the new set of accessibility preferences:
transmit, to the content producer computing platform, a template comprising accessibility-compliant design data corresponding to the new set of accessibility preferences.

9. The computing platform of claim 7, further comprising program instructions that are executable by the at least one processor such that the computing platform is configured to:
receive, from a third computing device associated with a third user, (i) a second request to create an accessibility theme for viewing digital content and (ii) an indication of a given impairment for the accessibility theme;
based on the respective sets of accessibility preferences for the plurality of users, identify one or more recommended accessibility preferences associated with the given impairment; and
cause the third computing device to display a respective indication of each recommended accessibility preference.

10. The computing platform of claim 1, wherein the set of accessibility preferences indicate one or more of (i) a text color preference, (ii) a background color preference, (iii) a font preference, (iv) border preferences, or (v) bevel preferences.

11. The computing platform of claim 1, wherein the set of accessibility preferences indicate one or more of (i) a target area preference, (ii) a grid system preference, (iii) animation preferences, or (iv) sound preferences.

12. A non-transitory computer-readable medium, wherein the non-transitory computer-readable medium is provisioned with program instructions that, when executed by at least one processor, cause a computing platform to:
receive, from a computing device associated with a given user, a request to create an accessibility theme for viewing digital content;
cause the computing device to display a series of user interface views that enable the given user to provide user input configuring the accessibility theme;
receive, from the computing device, data indicating a set of accessibility preferences that define how digital content is to be published for display to the given user according to the accessibility theme;
cause storage of profile data in association with the given user, the profile data indicating the set of accessibility preferences that define how content is to be published for display to the given user according to the accessibility theme;
receive, from the computing device, data indicating user authorization to share the set of accessibility preferences with one or more content producers;
based on receiving the data indicating the user authorization, transmit, to the computing device, an access token for accessing the set of accessibility preferences;
after transmitting the access token to the computing device, receive, from a content producer computing platform, a request for the set of accessibility preferences, the request comprising the access token; and
based on receiving the request for the set of accessibility preferences comprising the access token, transmit the set of accessibility preferences to the content producer computing platform.

13. The non-transitory computer-readable medium of claim 12, wherein the non-transitory computer-readable medium is also provisioned with program instructions that, when executed by at least one processor, cause the computing platform to:
receive, from the computing device, an indication of a given user impairment, wherein the profile data further comprises data indicating the given user impairment.

14. The non-transitory computer-readable medium of claim 12, wherein the non-transitory computer-readable medium is also provisioned with program instructions that, when executed by at least one processor, cause the computing platform to:
based on receiving the data indicating the user authorization to share the set of accessibility preferences with one or more content producers, generate the access token; and
before transmitting the set of accessibility preferences to the content producer computing platform, validate the access token received from the content producer computing platform.

15. The non-transitory computer-readable medium of claim 12, wherein the non-transitory computer-readable medium is also provisioned with program instructions that, when executed by at least one processor, cause the computing platform to:
based on the set of accessibility preferences, generate a template comprising accessibility-compliant design data that is usable by the content producer computing platform for publishing content according to the accessibility theme; and
wherein the program instructions that are executable by the at least one processor such that the computing platform is configured to transmit the set of accessibility preferences to the content producer computing platform comprises program instructions that are executable by the at least one processor such that the computing platform is configured to:
transmit the template to the content producer computing platform.

16. The non-transitory computer-readable medium of claim 15, wherein the template comprises a cascading style sheet (CSS) file or a JavaScript object notation (JSON) file.

17. The non-transitory computer-readable medium of claim 12, wherein:
the computing device is a first computing device;
the given user is a first user;
the set of accessibility preferences is a first set of accessibility preferences;
the accessibility theme is a first accessibility theme; and
the non-transitory computer-readable medium is also provisioned with program instructions that, when executed by at least one processor, cause the computing platform to:
receive, from a second computing device associated with a second user, data indicating a second set of accessibility preferences that define how digital content is to be published for display to the second user according to a second accessibility theme;
cause storage of profile data in association with the second user, the profile data indicating the second set of accessibility preferences that define how content is to be published for display to the second user according to the second accessibility theme; and
based on at least (i) the first set of accessibility preferences and (ii) the second set of accessibility preferences, generate a new set of accessibility preferences that define how content is to be published for display according to a new accessibility theme.

18. A method carried out by a computing platform, the method comprising:
receiving, from a computing device associated with a given user, a request to create an accessibility theme for viewing digital content;
causing the computing device to display a series of user interface views that enable the given user to provide user input configuring the accessibility theme;
receiving, from the computing device, data indicating a set of accessibility preferences that define how digital content is to be published for display to the given user according to the accessibility theme;
causing storage of profile data in association with the given user, the profile data indicating the set of accessibility preferences that define how content is to be published for display to the given user according to the accessibility theme;
receiving, from the computing device, data indicating user authorization to share the set of accessibility preferences with one or more content producers;
based on receiving the data indicating the user authorization, transmitting, to the computing device, an access token for accessing the set of accessibility preferences;
after transmitting the access token to the computing device, receiving, from a content producer computing platform, a request for the set of accessibility preferences, the request comprising the access token; and
based on receiving the request for the set of accessibility preferences comprising the access token, transmitting the set of accessibility preferences to the content producer computing platform.

19. The method of claim 18, further comprising:
receiving, from the computing device, an indication of a given user impairment, wherein the profile data further comprises data indicating the given user impairment.

20. The method of claim 18, further comprising:
based on receiving the data indicating the user authorization to share the set of accessibility preferences with one or more content producers, generating the access token; and
before transmitting the set of accessibility preferences to the content producer computing platform, validating the access token received from the content producer computing platform.
